(19) United States
(12) Patent Application Publication
(10) Pub. No.: US 2009/0033555 A1
(43) Pub. Date: Feb. 5, 2009

(54) Method and system for analog beamforming in wireless communications

(75) Inventors: Huaning Niu, Sunnyvale, CA (US); Pengfei Xia, Mountain View, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd, Suwon City (KR)

(21) Appl. No.: 11/890,207

(22) Filed: Aug. 2, 2007

(51) Int. Cl. H01Q 3/26; H01Q 3/00

(52) U.S. Cl. 342/372; 342/368

(57) ABSTRACT

A method and system for analog beamforming for wireless communication is provided. Such analog beamforming involves performing channel sounding to obtain channel sounding information, determining statistical channel information based on the channel sounding information, and determining analog beamforming coefficients based on the statistical channel information, for analog beamforming communication over multiple antennas.

### FIELD OF THE INVENTION

The present invention relates to wireless communications, and in particular, to beamforming transmissions in wireless channels.

### BACKGROUND OF THE INVENTION

With the proliferation of high quality video, an increasing number of electronic devices (e.g., consumer electronics (CE) devices) utilize high-definition (HD) video. Conventionally, most systems compress HD content, which can be around 1 gigabits per second (Gbps) in bandwidth, to a fraction of its size to allow for transmission between devices. However, with each compression and subsequent decompression of the signal, some data can be lost and the picture quality can be degraded.

The existing High-Definition Multimedia Interface (HDMI) specification allows for transfer of uncompressed HD signals between devices via a cable. While consumer electronics makers are beginning to offer HDMI-compatible equipment, there is not yet a suitable wireless (e.g., radio frequency (RF)) technology that is capable of transmitting uncompressed HD signals. For example, conventional wireless local area networks (LAN) and similar technologies can suffer interference issues when wireless stations do not have sufficient bandwidth to carry uncompressed HD signals.

Antenna array beamforming has been used to increase bandwidth and signal quality (high directional antenna gain), and to extend communication range by steering the transmitted signal in a narrow direction. However, conventional digital antenna array beamforming is an expensive process, requiring multiple expensive radio frequency chains connected to multiple antennas.

### BRIEF SUMMARY OF THE INVENTION

The present invention provides a method and system for analog beamforming for wireless communication. In one embodiment, such analog beamforming involves performing channel sounding to obtain channel sounding information, determining statistical channel information based on the channel sounding information, and determining analog beamforming coefficients based on the statistical channel information, for analog beamforming communication over multiple antennas.

In one implementation, direction-of-arrival and direction-of-departure information is determined from the statistical channel information. Determining analog beamforming coefficients includes determining transmitter power level coefficients and phase coefficients from the direction-of-departure information. In addition, determining analog beamforming coefficients involves determining receiver power level coefficients and phase coefficients from direction-of-arrival information. A transmitter station performs analog beamforming based on the transmit power level and phase coefficients, and a receiver station performs analog beamforming based on the receiver power level and phase coefficients.

These and other features, aspects and advantages of the present invention will become understood with reference to the following description, appended claims and accompanying figures.

### BRIEF DESCRIPTION OF THE DRAWINGS

FIG. 1 shows a block diagram of an orthogonal frequency division multiplexing (OFDM) wireless transmitter that implements an analog beamforming method, according to an embodiment of the present invention.

FIG. 2 shows a functional diagram of the analog transmit beamforming method of transmitter of FIG. 1, according to an embodiment of the present invention.

FIG. 3 shows a flowchart of the steps of an analog transmit beamforming process, according to an embodiment of the present invention.

FIG. 4 shows a functional diagram of an OFDM wireless station that implements receive analog beamforming, corresponding to the transmit analog beamforming in the wireless station of FIG. 2, according to an embodiment of the present invention.

FIG. 5 shows a flowchart of the steps of an analog receive beamforming process, according to an embodiment of the present invention.

### DETAILED DESCRIPTION OF THE INVENTION

The present invention provides a method and system for analog beamforming in wireless communications. In one embodiment, the present invention provides a method and system for analog beamforming using statistical channel knowledge for wireless communications between a transmit station and a receive station. An analog domain antenna array beamforming process allows the transmit station and the receive station to perform analog beamforming based on statistical channel information providing direction-of-arrival and direction-of-arrival information. The transmit station performs analog beamforming based on direction-of-departure information, and the receive station performs analog beamforming based on direction-of-arrival information.

In one example implementation described below, such analog beamforming is utilized for transmission of uncompressed video signals (e.g., uncompressed HD video content), in a 60 GHz frequency band such as in WirelessHD (WiHD) applications. WiHD is an industry-led effort to define a wireless digital network interface specification for wireless HD digital signal transmission on the 60 GHz frequency band, (e.g., for CE devices).

For wireless transmission of uncompressed HD video signals due to large bandwidth and low spectrum efficiency, reliable transmission of a single uncompressed video stream is sufficient. Therefore, analog beamforming using an RF chain for multiple antennas in an array (as opposed to an RF chain per antenna in digital beamforming), reduces the RF chain cost while maintaining an antenna array gain. Since the transmission frequency is high, the transmitter antenna spacing is very small. Therefore, in transmitter fabrication, multiple antennas can be mounted in one chip. Using such analog beamforming, a large array gain can be achieved to improve the video transmission quality.

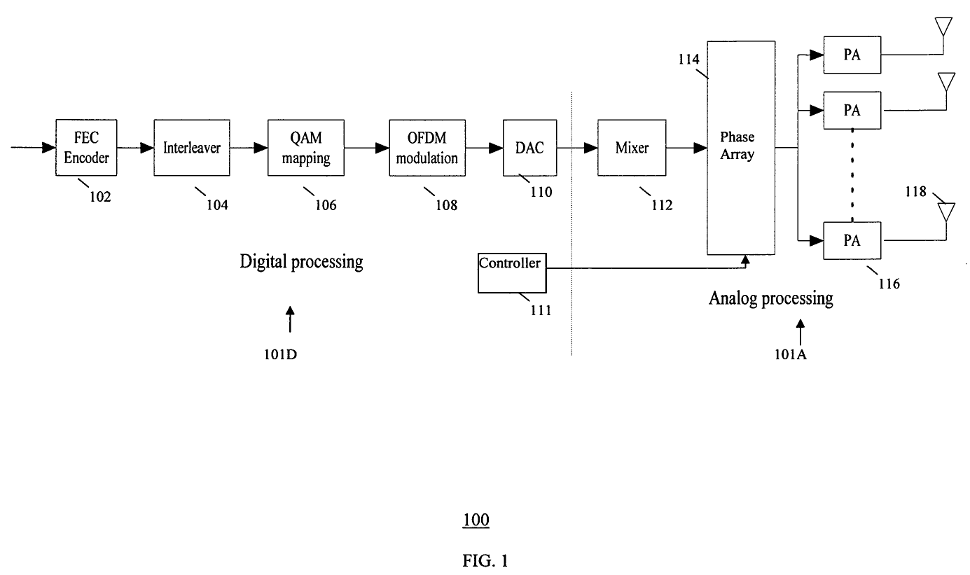

FIG. 1 shows a block diagram of a wireless station 100 implementing analog beamforming using statistical (e.g., estimated) channel information, according to an embodiment of the present invention. Such a wireless station is useful in wireless transmission of uncompressed video signals such as in WiHD applications. The wireless station 100 utilizes OFDM, and includes a digital processing section 101D and an analog processing section 101A.

The digital processing section 101D has one RF chain including a forward error correction (FEC) encoder 102, an interleaver 104, a Quadrature Amplitude Modulation (QAM) mapper 106, an OFDM modulator 108, a digital-to-analog converter (DAC) 110 and a controller 111. The analog section 101A includes a mixer 112, a phase (phase shift) array 114, and an array of multiple power amplifiers (PAs) 116 corresponding to multiple antennas 118. The controller 111 provides transmit phase and amplitude coefficients to the phase and amplifier arrays 114 and 116, respectively, for transmit analog beamforming.

The FEC encoder 102 encodes an input bit stream, and the interleaver 104 interleaves the encoded bit using block interleaving. Then, the QAM mapper 106 maps the interleaved bits to symbols using a Gray mapping rule. The OFDM modulator 108 performs OFDM modulation on the symbols, and the DAC 110 generates a baseband signal from OFDM modulated symbols.

In the analog processing section 101A, the analog signal from the DAC 110 is provided to the mixer 112 which modulates the analog signal from baseband up to the transmission frequency (e.g., 60 GHz). The modulated signal is then input to the phase array 114, which in conjunction with the controller 111, applies a coefficient vector W_{T} (i.e., weighting coefficients) thereto for transmission beamforming. The weighted signals are then amplified via the PA116 for transmission through an array of N transmit antennas 118.

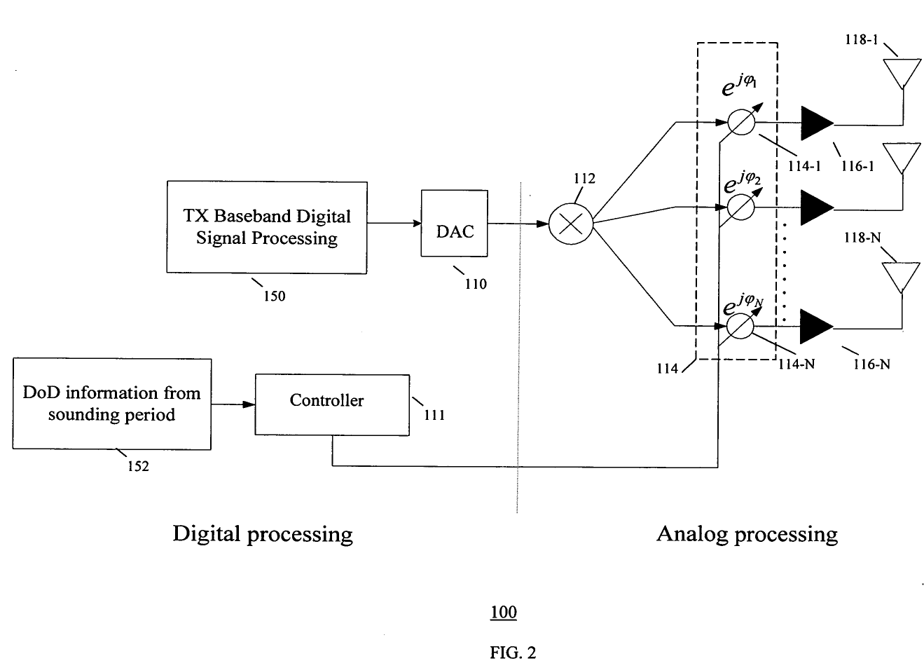

FIG. 2 shows an example functional diagram of the analog transmit beamforming method of the wireless station of FIG. 1. The FEC encoder 102, the interleaver 104, the QAM mapper 106, and the OFDM modulator 108 in FIG. 1, collectively perform transmission baseband digital signal processing, shown as a processing module 150 in FIG. 2.

The digital output of the processing module 150 is then converted to an analog signal by the DAC 110, and provided to the mixer 112 which modulates the analog signal to a 60 GHz transmission frequency. The phase array 114, in conjunction with the controller 111, applies the coefficient vector W_{T} to the modulated signal for transmit beamforming. As such, the analog data signals from the DAC 110 are transmitted over a channel via transmit antennas 118 by steering and amplifying the analog data signals using the transmit beamforming vector W_{T}.

The transmit beamforming coefficient vector W_{T} comprises elements e^{jφ}₁, . . . , e^{jφ}_{N}, wherein φ₁, . . . , φ_{N} are beamforming phase coefficients that are calculated by the controller 111 and controlled digitally at the baseband. Preferably, the coefficient vector W_{T} is an optimal coefficient. A direction of departure (DoD) function 152 estimates the direction of departure information θ_{T} based on the statistical channel information obtained during a channel sounding period.

A channel sounding period includes a training period, in which a sounding packet exchange can be implemented by generating a training request (TRQ) specifying a number of training fields, and transmitting a TRQ from a transmit station (initiator) having multiple antennas to a receive station (responder) over a wireless channel, wherein the TRQ specifies the number of training fields based on the number of transmit antennas. The receive station then transmits a sounding packet to the transmit station, wherein the sounding packet includes multiple training fields corresponding to the number of training fields specified in the TRQ. Based on the sounding packet, the wireless station transmits a beamforming transmission to the receive station to enable wireless data communication therebetween. This provides a sounding packet format and an exchange protocol for wireless beamforming using statistical channel information.

Specifically, the controller 111 determines a transmit channel correlation matrix R_{T} based on the DoD information θ_{T} from the channel sounding information. Then, the transmit phase coefficients φ₁, . . . , φ_{N} and amplitude (power lever) coefficients [α₁, . . . , α_{N}] are determined based on the transmit channel correlation matrix R_{T} (detailed further below), wherein the transmit beamforming coefficient vector W_{T}=[α₁e^{jφ}^{₁}, . . . , α_{N}e^{jφ}^{_{N}}], is related only to the transmit correlation matrix R_{T}.

The coefficient vector W_{T} includes complex numbers as phase (weighting) coefficients, wherein the phase coefficient φ₁, . . . , φ_{N} are applied to the frequency band signals by N phase array elements 114-1, . . . , 114-N, respectively. Then, the amplitude coefficients [α₁, . . . , α_{N}] are applied to the phase shifted signal (i.e., the analog beamformed signal) from the phase array elements 114-1, . . . , 114-N, by N power amplifiers 116-1, . . . , 116-N, respectively. [Comment: in FIG. 2, the direction of PA 116 should be reversed. Please correct.] The signals amplified by the amplifiers 116-1, . . . , 116-N are wirelessly transmitted to a receive station via the N antennas 118-1, . . . , 118-N.

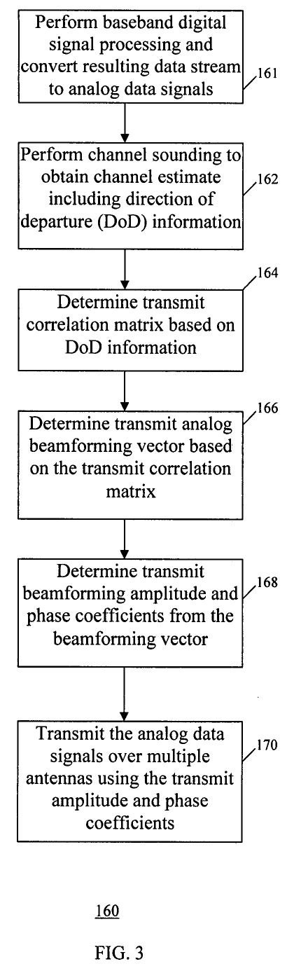

FIG. 3 shows a flowchart of the steps of the example transmit analog beamforming process 160 implemented in FIG. 2, including the steps of:
Step 161: Perform baseband digital signal processing and convert the resulting data stream to analog data signals.
Step 162: Perform channel sounding to obtain a channel estimate including direction of departure (DoD) information θ_{T} based on the sounding period information.
Step 164: Determine the transmit channel correlation matrix R_{T} based on the DoD information θ_{T}.
Step 166: Determine the transmitter beamforming vector W_{T}=[α₁e^{jφ}^{₁}, . . . , α_{N}e^{jφ}^{_{N}}] based on the correlation matrix R_{T}.
Step 168: Determine the transmit beamforming phase coefficients φ₁, . . . , φ_{N} and amplitude coefficients [α₁, . . . , α_{N}] from the beamforming vector W_{T}=[α₁e^{jφ}^{₁}, . . . , α_{N}e^{jφ}^{_{N}}].
Step 170: Transmit the analog signals to a receive station from a transmit station over transmitter antennas, by steering and amplifying the analog data signals using the phase and amplitude coefficients, respectively. The signals are transmitted via a wireless communication medium (e.g., over RF communication channels).

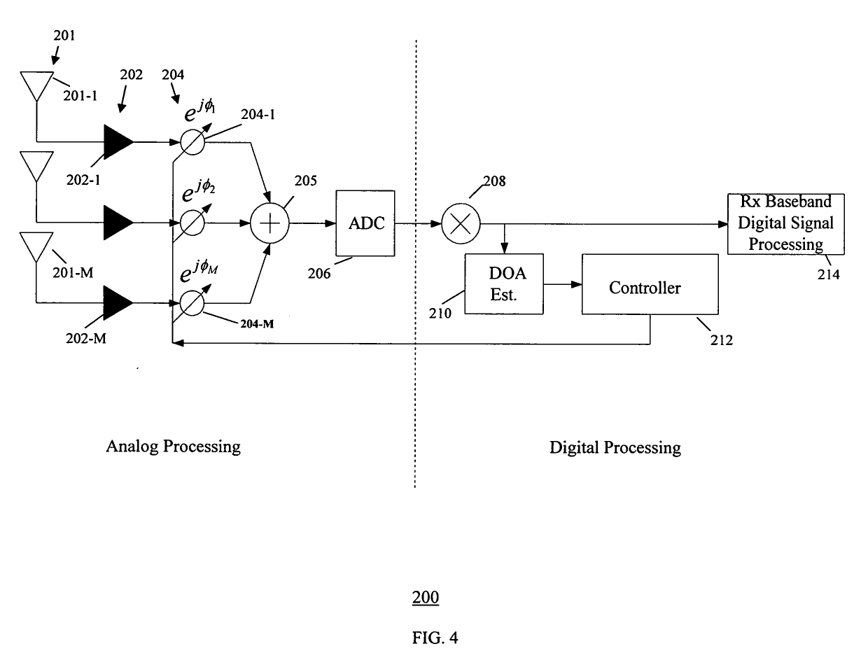

FIG. 4 shows a functional diagram of an OFDM wireless station 200 that implements receive analog beamforming, corresponding to the transmit analog beamforming in wireless station 100, according to an embodiment of the present invention. The station 200 includes an antenna array 201 (including M receive antennas 201-1, . . . , 201-M), a power amplifier array 202 (including M amplifiers 202-1, . . . , 202-M), a phase shift array 204 (including M phase elements 204-1, . . . , 204-M), a combiner function 205 which coherently combines the outputs of the phase shift array 204, an analog-to-digital converter (ADC) 206, a mixer function 208 which down-converts the RF signal from the ADC 206 to baseband for digital signal processing, a direction of arrival (DoA) estimation function 210, a baseband processing function 214 and a controller 212 that provides receive phase and amplitude coefficients to the amplifier and phase shift arrays 202 and 204, respectively, for receive analog beamforming.

In operation, the transmitted signals are received by the antenna array 201, and amplified by the amplifier array 202 using receive amplitude (power level) coefficients β₁, . . . , β_{M}. The amplified signals are processed in the phase shift array 204 using the receive phase coefficients Φ₁, . . . , Φ_{M}. The receive amplitude and phase coefficients are determined by the controller 212, and together form a receive beamforming coefficient vector W_{R}=[β₁e^{jΦ}, . . . , β_{N}e^{jΦ}^{_{M}}] which comprises elements e^{jΦ}₁, . . . , e^{jΦ}_{M}. The output of the phase elements 204-1, . . . , 204-M of the phase shift array 204, representing an analog beamformed signal, is provided to the combiner function 205 which combines them together for high signal power.

The output of the combiner function module 205 (i.e., a combined output of the receive analog beamformed signal) is converted to a digital signal by the ADC 206, and provided to the mixer function 208 for conversion to baseband. The baseband output of the mixer function 208 is provided to the baseband digital signal processor 214 for conventional receiver processing.

The output of the mixer function 208 is also provided to the DoA estimator 210 to estimate the DoA information θ_{R} (i.e., the channel statistical information) from the sounding information (similar to that described above in relation to the station 100). The controller 212 uses the DoA information θ_{R} to determine a receive channel correlation matrix R_{R}. Then, the receive phase coefficients Φ₁, . . . , Φ_{M} are determined based on the receive channel correlation matrix R_{R} (detailed further below). As such, the receive beamforming coefficient vector W_{R} is related only to the receive correlation matrix R_{R}.

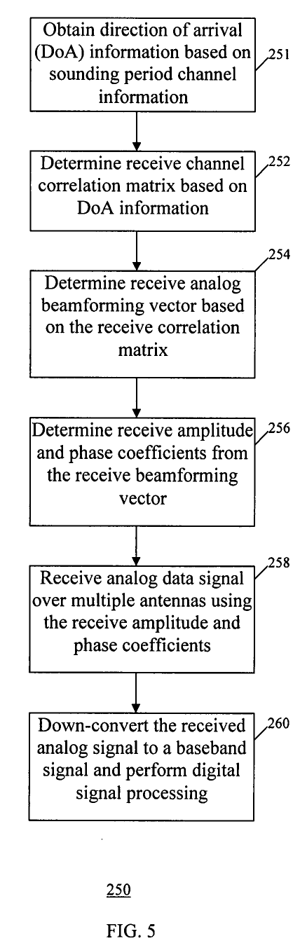

FIG. 5 shows a flowchart of the steps of the example receive analog beamforming process 250 implemented in the station 200 of FIG. 2, including the steps of:
Step 251: Obtain the DoA information θ_{R} based on the sounding period channel estimation information.
Step 252: Determine the receive channel correlation matrix R_{R} based on the DoA information θ_{R}.
Step 254: Determine the receive beamforming vector W_{R}=[β₁e^{jΦ}^{₁}, . . . , β_{N}e^{jΦ}^{_{M}}] based on the receive correlation matrix R_{R}.
Step 256: Determine the transmit beamforming amplitude coefficients β₁, . . . , β_{M} and phase coefficients φ₁, . . . , φ_{N} from the receive beamforming vector.
Step 258: Receive the analog signals using the receive amplitude and phase coefficients.
Step 260: The received analog signal is down-converted to a baseband signal for digital signal processing.

As noted, the transmitter beamforming coefficient vector W_{T} is related only to the channel correlation matrix R_{T}, and the receiver beamforming coefficient vector W_{R} is related only to the channel correlation matrix R_{R}. A channel matrix H can be modeled as:

H=R_{R}^{1/2}H_{W}R_{T}^{1/2},

wherein elements of matrix H_{W} are independent and identically distributed (i.i.d.) complex Gaussian distributed, with a zero mean and unit covariance, and wherein:

$$[ {R}_{T} ] m , n = exp ( - j2π ( m - n ) {Δ }_{T} cos ( {θ}_{T} ) ) \cdot exp ( - {\frac{1}{2} [ 2 π ( m - n ) {Δ}_{T} sin ( {θ}_{T} ) {σ}_{T} ]}^{2} ) \\ [ {R}_{R} ] m , n = exp ( - j2π ( n - m ) {Δ }_{R} cos ( {θ}_{R} ) ) \cdot exp ( - {\frac{1}{2} [ 2 π ( n - m ) {Δ}_{R} sin ( {θ}_{R} ) {σ}_{R} ]}^{2} )$$

where θ_{T}, θ_{R} are the angle of departure from the transmitter and the angle of arrival to the receiver, σ_{T},σ_{R} are angle spreads at the transmitter and the receiver, Δ_{T},Δ_{R} are the distance between the adjacent antenna elements in terms of carrier wavelength:

wherein m and n are the element index in each matrix.

The transmit beamforming vector W_{T}=e^{jφ}₁, . . . , e^{jφ}_{N} is determined based on the transmit channel correlation matrix R_{T} as follows. The correlation matrix R_{T} is used to calculate U_{T} which is a unitary vector that comprises right singular vectors of R_{T}, such that:
R_{T}=U_{T}Λ_{T}U_{T}*, wherein * means conjugate transpose.

The transmit beamforming vector W_{T} is determined as W_{T}=U_{T}.

Similarly, the receive beamforming vector W_{R}=[β₁e^{jΦ}^{₁}, . . . , β_{N}e^{jΦ}^{_{M}}] is determined based on the receive channel correlation matrix R_{R} as follows. The receive channel correlation matrix R_{R} is used to calculate U_{R} which is a unitary vector that comprises right singular vectors of R_{R}, such that:

R_{R}=U_{R}Λ_{R}U_{R}*.

Then, the receiver beamforming vector W_{R} is determined as W_{R}=U_{R}.

An analog domain antenna array beamforming process based on the channel statistical information direction-of-arrival and direction-of-departure information provides simplified and efficient wireless communication, compared to digital beamforming such as eigen-based beamforming techniques which typically require multiple RF chains corresponding to multiple antennas.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

1. A method of analog beamforming for wireless communication, comprising:
performing channel sounding to obtain channel sounding information;
determining statistical channel information based on the channel sounding information; and
determining analog beamforming coefficients based on the statistical channel information, for analog beamforming communication over multiple antennas using a single RF chain.

2. The method of claim 1 wherein determining analog beamforming coefficients based on the statistical channel information further includes determining power level coefficients based on the statistical channel information for analog beamforming over multiple antennas.

3. The method of claim 1 wherein determining analog beamforming coefficients based on the statistical channel information further includes determining phase coefficients based on the statistical channel information for analog beamforming over multiple antennas.

4. The method of claim 1 wherein determining analog beamforming coefficients based on the statistical channel information further includes:
determining power level coefficients based on the statistical channel information;
determining phase coefficients based on the statistical channel information; and
determining analog beamforming coefficients based on the power level coefficients and the phase coefficients, for analog beamforming over multiple antennas.

5. The method of claim 1 wherein determining statistical channel information includes estimating the channel based on the channel sounding information.

6. The method of claim 1 wherein determining statistical channel information further includes determining the direction-of-departure information.

7. The method of claim 6 wherein determining analog beamforming coefficients further includes determining transmit analog beamforming coefficients based on the direction-of-departure information.

8. The method of claim 1 wherein determining statistical channel information further includes determining the direction-of-arrival information.

9. The method of claim 8 wherein determining analog beamforming coefficients further includes determining receive analog beamforming coefficients based on the direction-of-arrival information.

10. The method of claim 1 wherein determining analog beamforming coefficients further includes:
determining a transmit correlation matrix based on the statistical channel information; and
determining transmit analog beamforming coefficients based on the transmit correlation matrix.

11. The method of claim 10 wherein determining the transmit correlation matrix based on the statistical channel information further includes:
estimating the direction-of-departure information from the channel sounding information; and
determining the transmit correlation matrix based on the direction-of-departure information.

12. The method of claim 10 wherein determining analog beamforming coefficients further includes:
determining the transmit beamforming phase coefficients based on the transmit correlation matrix; and
determining a transmit analog beamforming vector based on the transmit beamforming phase coefficients.

13. The method of claim 10 wherein determining analog beamforming coefficients further includes:
determining the transmit beamforming power level coefficients based on the transmit correlation matrix; and
determining a transmit analog beamforming vector based on the transmit beamforming power level coefficients.

14. The method of claim 1 wherein determining analog beamforming coefficients further includes:
determining a receive correlation matrix based on the statistical channel information; and
determining the receive analog beamforming coefficients based on the receive correlation matrix.

15. The method of claim 14 wherein determining the receive correlation matrix based on the statistical channel information further includes:
estimating the direction-of-arrival information from the channel sounding information; and
determining the receive correlation matrix based on the direction-of-arrival information.

16. The method of claim 14 wherein determining the analog beamforming coefficients further includes:
determining the receive beamforming phase coefficients based on the receive correlation matrix; and
determining a receive analog beamforming vector based on the receive beamforming phase coefficients.

17. The method of claim 14 wherein determining the analog beamforming coefficients further includes:
determining the receive beamforming power level coefficients based on the receive correlation matrix; and
determining a receive analog beamforming vector based on the receive beamforming power level coefficients.

18. The method of claim 1 wherein:
determining the analog beamforming coefficients based on the statistical channel information includes determining the power level coefficients based on the statistical channel information, determining phase coefficients based on the statistical channel information; and
communicating analog signals over a wireless channel by amplifying and steering the analog signals using the power level coefficients and the phase coefficients, respectively.

19. The method of claim 18 wherein:
determining analog beamforming coefficients further includes determining analog transmit power levels and phase coefficients based on direction-of-departure information from the channel statistical information; and
communicating uncompressed high definition video signals over a wireless channel includes transmitting analog signals over multiple antennas by steering and amplifying the analog signals using the transmit phase coefficients and the transmit power level coefficients, respectively, using orthogonal frequency division multiplexing in a 60 GHz frequency band.

20. The method of claim 18 wherein:
determining analog beamforming coefficients further includes determining analog receive power level and phase coefficients based on direction-of-arrival information from the channel statistical information; and
communicating uncompressed high definition video signals over a wireless channel includes receiving analog signals over multiple antennas by amplifying and steering the analog signals using the receive power level coefficients and the receive phase coefficients, respectively, using orthogonal frequency division multiplexing in a 60 GHz frequency band.

21. A wireless station for analog beamforming communication, comprising:
an estimator configured for determining statistical channel information based on the channel sounding information; and
a controller configured for determining analog beamforming coefficients based on the statistical channel information, for analog beamforming communication over multiple antennas using a single RF chain.

22. The wireless station of claim 21 wherein the controller is configured for determining analog beamforming power level coefficients based on the statistical channel information for analog beamforming over multiple antennas.

23. The wireless station of claim 21 wherein the controller is configured for determining analog beamforming phase coefficients based on the statistical channel information for analog beamforming over multiple antennas.

24. The wireless station of claim 21 wherein the controller is configured for determining analog beamforming power level coefficients and phase coefficients based on the statistical channel information, and determining analog beamforming coefficients based on the power level coefficients and the phase coefficients, for analog beamforming over multiple antennas.

25. The wireless station of claim 21 wherein the estimator is configured for determining statistical channel information by estimating the channel based on the channel sounding information.

26. The wireless station of claim 21 wherein the estimator is configured for determining statistical channel information by estimating direction-of-departure information, and the controller is further configured for determining analog beamforming coefficients based on the direction-of-departure information.

27. The wireless station of claim 21 wherein the estimator is further configured for determining statistical channel information by estimating direction-of-arrival information, and the controller is further configured for determining analog beamforming coefficients based on direction-of-arrival information.

28. A wireless transmitter for analog beamforming communication, comprising:
an estimator configured for determining statistical channel information based on channel sounding information;
a controller configured for determining analog beamforming phase and power level coefficients based on the statistical channel information, for analog beamforming transmission over an antenna array using a single RF chain; and
a phase shifter array and an amplifier array, corresponding to the antenna array, the phase shifter array configured for steering analog data signals based on the phase coefficients to generate beamformed signals, and the amplifier array configured for amplifying the beamformed signals based on the power level coefficients, for transmission over the antenna array.

29. The wireless transmitter of claim 28 wherein the estimator is configured for determining statistical channel information by estimating the direction-of-departure information and the controller is configured for determining the phase and power level coefficients based on the direction-of-departure information.

30. The wireless transmitter of claim 28 wherein the controller is configured for determining a transmit correlation matrix based on the direction-of-departure information, and determining the phase and power level coefficients based on the transmit correlation matrix.

31. A wireless receiver for analog beamforming communication, comprising:
an estimator configured for determining statistical channel information based on channel sounding information;
a controller configured for determining analog beamforming phase and power level coefficients based on the statistical channel information, for analog beamforming reception over an antenna array using a single RF chain; and
an amplifier array and a phase shifter array, corresponding to the antenna array for receiving analog signals, the amplifier array configured for amplifying the received signals based on the power level coefficients, and the phase shifter array configured for steering analog data signals based on the phase coefficients to generate beamformed signals.

32. The wireless receiver of claim 31 wherein the estimator is configured for determining statistical channel information by estimating the direction-of-arrival information and the controller is configured for determining the phase and power level coefficients based on the direction-of-arrival information.

33. The wireless receiver of claim 31 wherein the controller is configured for determining a receive correlation matrix based on the direction-of-arrival information, and determining the phase and power level coefficients based on the receive correlation matrix.

34. The method of claim 1, wherein the single RF chain including a single encoder and a single modulator.
